(19) United States
(12) Patent Application Publication
(10) Pub. No.: US 2003/0142606 A1
(43) Pub. Date: Jul. 31, 2003

(54) Information recording apparatus and method

(75) Inventors: Akihito Ogawa, Yokohama-shi (JP); Maho Kuwahara, Tokyo (JP); Kazuo Watabe, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/329,980

(22) Filed: Dec. 27, 2002

(30) Foreign Application Priority Data
Dec. 27, 2001 (JP) 2001-398176

(51) Int. Cl. G11B 7/00

(52) U.S. Cl. 369/59.11

(57) ABSTRACT

An information recording apparatus varies an output level of laser light according to the length of a segment in which information is to be erased when information recorded on an information recording medium is erased by use of laser light of a preset output level.

### CROSS-REFERENCE TO RELATED APPLICATIONS

This application is based upon and claims the benefit of priority from the prior Japanese Patent Application No. 2001-398176, filed Dec. 27, 2001, the entire contents of which are incorporated herein by reference.

### BACKGROUND OF THE INVENTION

1. Field of the Invention

This invention relates to an information recording apparatus and method for recording information on an information recording medium. Particularly, this invention can be effectively used to record information on a thermal recording type information recording medium and erase recorded information.

For example, as information recording mediums, there is DVD-RAM (Digital Versatile Disk Random Access Memory), DVD-RW (Rewritable), DVD-R (Recordable), CD-RW (Compact Disk), CD-R and the like.

2. Description of the Related Art

As is well known in the art, as a recordable and rewritable information recording medium, a thermal recording type information recording medium is provided, in which information is recorded by heating and cooling the information recording medium.

A typical example of a thermal recording type information recording medium is a phase change medium. A phase change medium records information based on a difference in the phase thereof, that is, a difference in the physical property between an amorphous state and crystalline state.

That is, there is a difference in the light reflection factor between the amorphous state and crystalline state. Therefore, it becomes possible to record information by arranging portions which are formed in an amorphous form and portions which are formed in a crystalline form along a track according to information to be recorded.

For example, in an optical disk apparatus using the phase change medium, the entire surface of the medium is previously crystallized by the initialization process. Then, amorphous recording marks are formed on the medium by applying an intense, pulsed laser light thereto.

This is because the crystallized portion is melted by application of the strong laser light, and then, the melted portion is rapidly cooled when the laser light applied thereto becomes weak and is converted into an amorphous form. The portion in the amorphous form is called a recording mark. As a result, the recording marks and spaces which are the crystallized portions are arranged along the track.

When information is reproduced, a weak laser light of a constant level is applied to the medium to read out recorded information by converting changes in the amount of light reflected from the amorphous-form portions that are the recording marks, and the crystallized portions, into an electrical signal.

As the phase change medium which is recently put into practice, there is provided a DVD-RAM [ISO (International Organization for Standardization)/IEC (International Electrotechnical Commission) 16824].

When information is recorded, the output level of laser light is cyclically controlled for a segment in which recording marks are to be formed so as to convert corresponding portions into an amorphous form by melting and rapidly cooling the medium. Further, the bias power which maintains the crystallized form is applied to a space between the recording marks.

That is, information is recorded or erased based on variation in the output level of laser light applied to the medium. The recording waveform obtained at this time is generally called a write strategy.

The write strategy is defined for each shape (pattern) of a recording mark to be formed. In the write strategy of DVD-RAM, three or four levels are provided as light outputs.

The light outputs include the peak power used to melt the phase change medium by heating the same to a temperature equal to or higher than the melting point thereof, the bias power (erase power) used to hold the temperature of the medium at the crystallization temperature for crystallization holding time, and the bias power (multi-bottom power) and bias power (off-pulse power) used to rapidly cool the melted medium and convert the same into an amorphous form.

In a DVD-RAM, the size and shape of a recording mark are adjusted with high precision by adjusting the above output levels of laser light.

Further, for DVD-RAM, each output level of laser light defined by the write strategy is made constant irrespective of the length of the recording mark and space. When a long recording mark is recorded, the number of cycles is increased, and when a short recording mark is recorded, the number of cycles is decreased.

Spaces are provided before and after the recording mark. The length of the space and the length of the recording mark correspond to the recording pulse waveform.

If a short space is provided immediately before or after the recording mark, heat used to form the recording mark may be transmitted to the space and melt it. This means that the space of a precise length cannot be formed, in other words, the precise shape of the recoding mark cannot be attained.

Further, if a short recording mark is formed immediately after a long space, the power of laser light is maintained at a bias power (erase power) in which the period of the space is constant, then changed to peak power used to melt the medium in a short period of time, then changed to bias power (off-pulse power) used to rapidly cool the melted medium and convert it into an amorphous form. As a result, the amount of heat at the time of formation of the space influences the recording mark forming portion, and sometimes the head portion of the recording mark is not formed in the precise position.

Jpn. Pat. Appln. KOKAI Publication Nos. 4-265522 and 11-102522 propose techniques for overcoming the above problem. An outline of the technique disclosed in Jpn. Pat. Appln. KOKAI Publication No. 4-265522 follows.

Attention is paid to mutual thermal interference occurring in the array of the recording mark, space, recording mark, space, . . . In order to suppress the thermal interference, the application energy in the leading edge and trailing edge of a laser light pulse is controlled to enhance the precision of formation of a recording mark.

That is, in the recording portion, a pulse (which is referred to as an off pulse) of power weaker than the erase power is added to not only the last portion of the light pulse but also the staring portion thereof. As a result, heat used to form the present recording mark can be prevented from being transmitted to a recording mark formed immediately thereafter, and heat used to form the next recording mark can be prevented from being transmitted to the previous recording mark. Further, since the power of the off pulse is weaker than the erase power, the degree of rapid cooling is significantly enhanced, enabling precise formation of recording marks.

An outline of the technique disclosed in Jpn. Pat. Appln. KOKAI Publication No. 11-102522 follows. In this publication also, attention is paid to mutual thermal interference occurring in the array of the recording mark, space, recording mark, space, . . . That is, the widths of the recording marks and spaces are detected and the light output level is changed according to a pattern indicating portions in which significantly strong thermal interference occurs.

However, the above methods have some problems. For example, in the above-described DVD-RAM, the problem of thermal interference cannot be sufficiently solved by use of the method for changing only the pulse width for each pattern of the recording marks and spaces or the length of the recording mark and space.

Further, in Jpn. Pat. Appln. KOKAI Publication No. 4-265522, an attempt is made to prevent thermal interference by arranging the off pulses before and after the recording pulse. However, there still occurs a problem that a recording mark formed by the rapid cooling effect of the off pulse may be re-crystallized by the erase power used after this, for example.

If the off pulse is made excessively long, the time required for switching circuits to output the next peak power cannot be attained and it becomes difficult to control the pulse.

Further, in Jpn. Pat. Appln. KOKAI Publication No. 11-102522, a method for increasing the recording peak power only for a recording mark immediately after the shortest space or the shortest mark in which significantly strong thermal interference occurs or applying an off pulse immediately before the peak power is proposed.

However, in the high-density recording operation, heat caused by application of pulses to form recording marks before and after recording marks surrounded by the shortest spaces leaks into the recording mark. Further, if the peak power is increased, the medium may be melted, but it cannot be rapidly cooled and there therefore occurs a problem that an amorphous recording mark cannot be formed with high precision.

In all of the above-described conventional techniques, attention is paid to the light pulse used to form recording marks. However, in the rewritable type optical disk, it is necessary to overwrite or erase the recording marks which have been already recorded, at the time of recording of new information. In the high-density recording operation, a problem occurs at the erase time of information.

That is, at the erase time of information, it is necessary to hold the temperature of the medium at the crystallization temperature for crystallization holding time. Therefore, the write strategy is made to set the erase power of laser light in a potion in which no recording mark is formed. The erase power is optimized to power which can hold the temperature of the medium at the crystallization temperature.

However, in the high-density recording operation, not only the recording mark but also the space between the recording marks is made shorter. In the case of such a short space, even if the erase power is output like the case of a long space, the heat amount of peak power to record recording marks immediately before and after the space leaks into the space portion, thus the temperature of the medium rises above the ideal temperature.

As a result, in the short space, the temperature of the medium exceeds the crystallization temperature and the space portion is melted, thus the recording mark cannot be erased. Further, even when the erase power is set at an intermediate point between the optimum point in the case of the short space and the optimum point in the case of the long space, a margin of the erase power cannot be obtained.

### BRIEF SUMMARY OF THE INVENTION

The present invention has been made in view of the above conditions and an object thereof is to provide an information recording apparatus and information recording method which can precisely form recording marks, reduce the load on a recording circuit and significantly improve the erase characteristic at the rewriting time and the erase power margin by utilizing plural types of erase powers.

According to one aspect of the present invention, there is provided an information recording apparatus comprising a circuit which changes an output level of laser light according to the length of a segment in which information is to be erased when information recorded on an information recording medium is erased by use of laser light of a preset output level.

### BRIEF DESCRIPTION OF THE SEVERAL VIEWS OF THE DRAWING

FIGS. 1A and 1B are diagrams showing a recording pattern and recording waveform, for illustrating one embodiment of the present invention,

FIG. 2 is a characteristic diagram for illustrating the relation between the erase rate and erase power corresponding to the recording waveform in the above embodiment,

FIGS. 3A and 3B are diagrams for illustrating variations in recording marks when overwriting occurs in the above embodiment,

FIG. 4 is a block diagram for illustrating an information recording/reproduction apparatus in the above embodiment,

FIGS. 5A to 5G are timing diagrams for illustrating the recording operation of the information recording/reproduction apparatus of the above embodiment,

FIG. 6 is a block diagram for illustrating a semiconductor laser unit of the above embodiment in detail,

FIGS. 7A to 7F are timing diagrams for illustrating another recording operation of the information recording/reproduction apparatus of the above embodiment,

FIGS. 8A and 8B are timing diagrams for illustrating a recording operation in comparison with the operation shown in the timing diagrams of FIGS. 7A to 7F,

FIGS. 9A to 9E are timing diagrams for illustrating still another recording operation of the information recording/reproduction apparatus of the above embodiment, and

FIGS. 10A to 10F are timing diagrams for illustrating another recording operation of the information recording/reproduction apparatus of the above embodiment.

### DETAILED DESCRIPTION OF THE INVENTION

There will now be described embodiments of this invention with reference to the accompanying drawings.

(Recording Strategy)

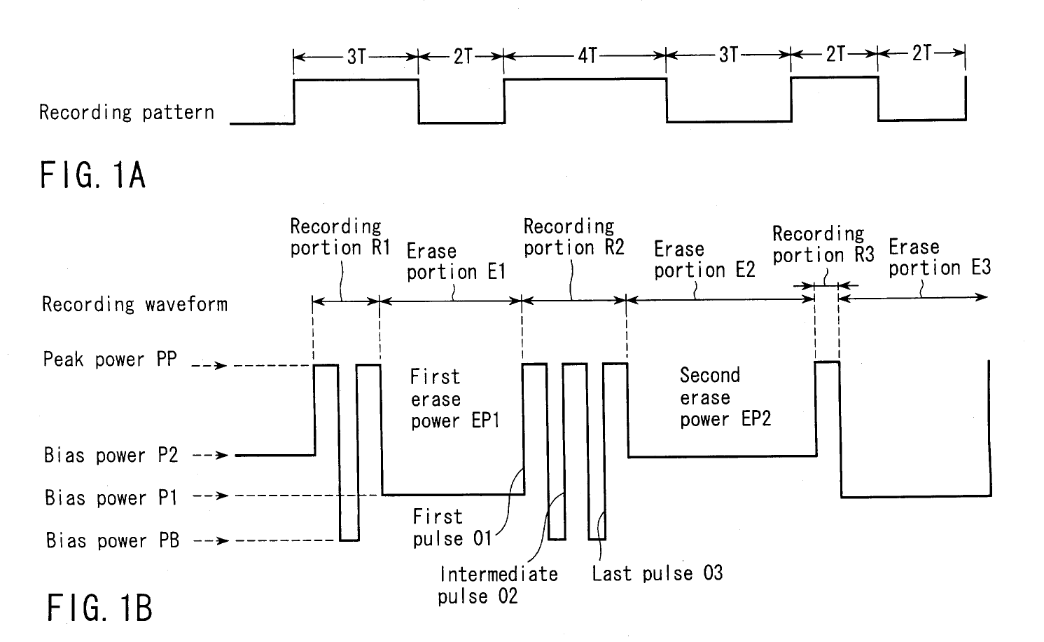

FIG. 1A shows part of a recording pattern of (1,7) RLL (Run Length Limited) modulation explained in the present embodiment and FIG. 1B shows a recording waveform corresponding to the recording pattern, that is, write strategy. The write strategy is roughly divided into recording periods or recording portions and erase periods or erase portions. In the following description, they are respectively explained as recording portions and erase portions.

FIG. 1B shows erase portions E1, E2, E3 and recoding potions R1, R2, R3 and a recording waveform of laser light corresponding to the above recording pattern. The maximum power of the laser light used to melt the medium is set at peak power PP in the recording potion and the initial power thereof used to cool the melted medium is set at bottom power PB.

Further, the laser light is controlled to be selectively set at two bias powers P1, P2 (P2>P1) which are characteristic to the present embodiment. The bias powers P1, P2 are used as erase powers to convert the medium into a crystallized form.

In the erase portions E1, E2, E3, the output level of the laser light is maintained at an erase power level as described above. In the recoding potions R1, R2, R3, the laser light is output in a multi-pulse form in which the light emission waveform is divided in a plurality of short pulses so as to form the medium into an amorphous form and form recording marks.

Each of the pulses configuring the multi-pulse is divided into a first pulse 01, intermediate pulse 02 and last pulse 03 based on the function thereof. The first pulse 01 is a pulse to heat the medium to a temperature higher than the melting point. The intermediate pulse 02 is configured by a heating portion which rises to the peak power PP and a cooling portion which falls to the bottom power PB.

An increase in the size of the recording mark due to excessive heating of the medium and a reduction in the size of the recording mark due to melting and re-crystallization of the medium can be suppressed by providing the cooling portion. Further, the last pulse 03 is a heating pulse and used to shape the trailing edge of the recording mark.

In the recording portions R1, R2, R3, the output levels of the laser lights caused by the respective pulses 01 to 03 are defined by the peak power PP and bottom power PB. In the erase portions E1, E2, E3, the intensities of light are kept constant and plural (two types in the present embodiment) intensities are appropriately used according to the length of the spaces.

That is, when the space is shorter than the specified length, the laser light is set to the bias power P1 as first erase power EP1, and when the space is longer than the specified length, the bias power P2 is set as second erase power EP2.

If light with the level of the bias power P1 or P2 is applied to the medium, the medium is heated to the crystallization temperature and held as it is at the crystallization temperature for crystallization holding time. As a result, the medium is formed into a crystallized form.

In the present embodiment, when 2T which is the shortest or minimum channel length, is used as a threshold value, the bias power P1 is assigned to the space of 2T and the bias power P2 is assigned to the longer space (equal to or longer than 3T).

(Erase Power Margin)

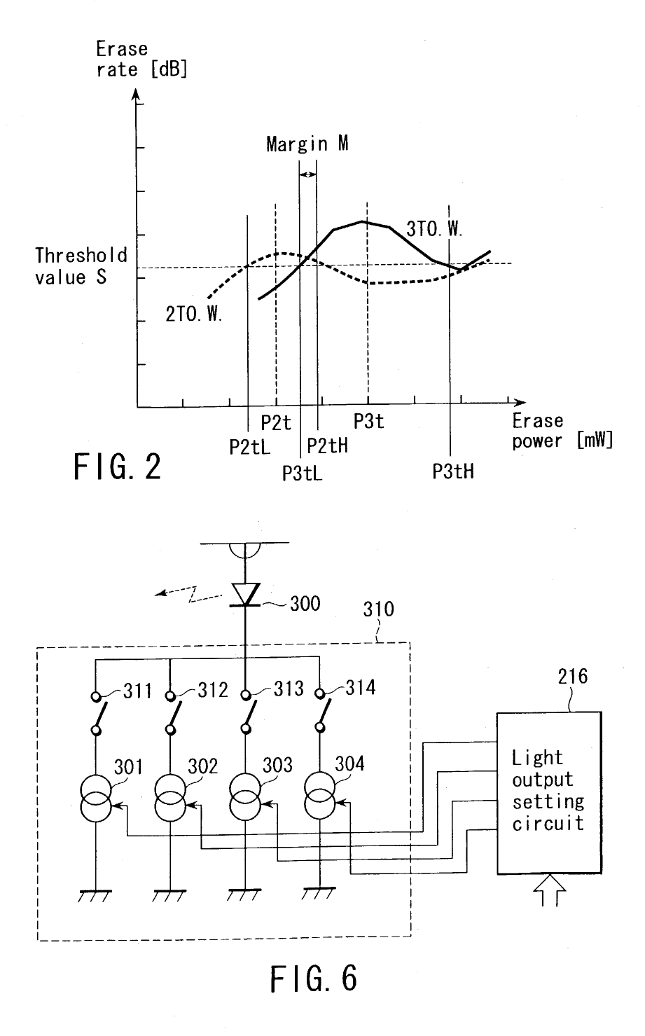

FIG. 2 shows the dependency of “2T overwrite 7T erase rate (2TO.W)” and “3T overwrite 7T erase rate (3TO.W)” on the erase power in the high-density recording operation.

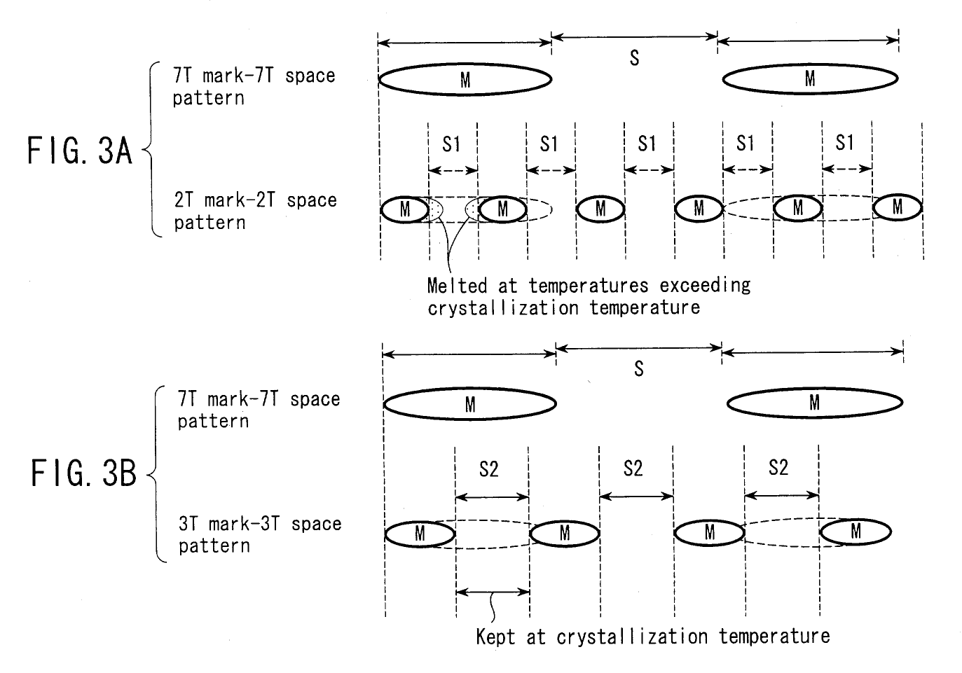

In this case, as shown in FIG. 3A, “2T overwrite 7T erase rate” indicates a reduction amount of the amplitude of a reproduced signal of a 7T mark-7T space pattern when a 2T mark-2T space pattern is overwritten on the 7T mark-7T space pattern.

Further, as shown in FIG. 3B, “3T overwrite 7T erase rate” indicates a reduction amount of the amplitude of a reproduced signal of a 7T mark-7T space pattern when a 3T or more mark-3T or more space pattern is overwritten on the 7T mark-7T space pattern. That is, the erase rate becomes so low that the 7T mark-7T space pattern will disappear.

In conventional DVDs, a pattern of 3T to 11T as the space length is used, but since any pattern has sufficient space length, the characteristic of the erase rate will not be greatly influenced by the length of the space.

On the other hand, in a high-density optical disk, the minimum space length is made smaller. As a result, as indicated by an erase portion S1 in FIG. 3A, when the space of the length which is as short as 2T is used, a heat amount is increased by leakage of heat from the recording power used for a recording mark which exists immediately before or after the above 2T space. As a result, the temperature of the medium exceeds the crystallization temperature and the medium is sometimes melted.

In contrast, as indicated by an erase portion S2 shown in FIG. 3B, when a long space is used, a heat amount is not significantly increased even if leakage of heat is caused from the surrounding portions into the space since application time of the erase power is sufficiently long.

Therefore, when a signal containing a short space such as a 2T space is overwritten by use of an erase power which is optimized for the length of a long space, the total erase rate is lowered in comparison with a case wherein a signal containing only long spaces is overwritten. That is, it is necessary to lower the optimum erase power in a 2T space portion in comparison with a long space portion by taking a leakage heat amount into consideration.

The result of the dependency on the erase power shown in FIG. 2 also indicates the above fact. That is, in a case where the 2T pattern is overwritten, the highest erase rate is obtained when the erase power is set at P2t. However, in a case where a pattern of 3T or more is overwritten, the highest erase rate is obtained when the erase power is set at P3t.

In this case, if a threshold value indicating the lower limit of the erase rate is indicated by S, a power margin of P3tL to P3tH can be attained for a pattern of 3T or more when the erase power is set at P3t in the conventional recording waveform. However, the erase power becomes lower than the threshold value S in the case of a 2T pattern.

Likewise, even if the erase power is set at P2t, the erase power becomes lower than the threshold value S in the case of a pattern of 3T or more. If the erase power is set at an intermediate value between P2t and P3t, the erase power can barely be set higher than the threshold value S in either one of the above patterns. However, since the erase power becomes lower than the threshold value S if the erase power fluctuates only slightly, the erase power margin M is extremely narrowed.

Therefore, in the present embodiment, as shown in FIG. 1B, the bias powers P1 and P2 are respectively set to P2t and P3t. As a result, the erase power becomes optimum for each space and it becomes possible to precisely form recording marks.

Further, even when the light output varies, a sufficiently large erase power margin M can be attained since the erase powers are respectively set to different values for the 2T space and the space of a different length.

(Recording Apparatus)

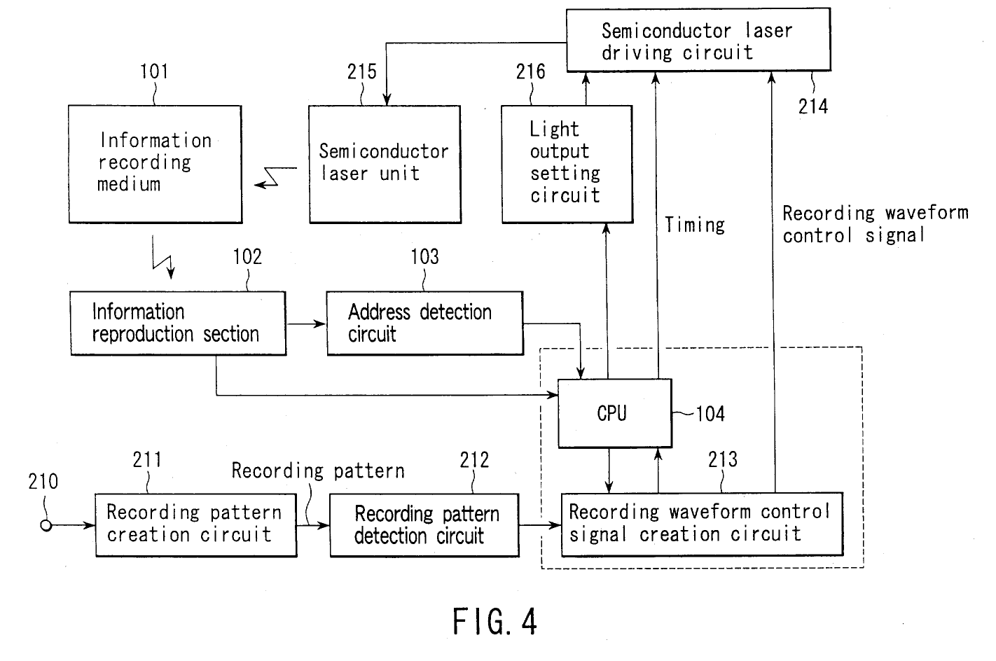

FIG. 4 shows an information recording/reproduction apparatus which records/reproduces information with respect to the above information recording medium. That is, an information reproduction section 102 reads out information associated with the information recording condition, information associated with addresses of an information recording medium 101 and the like from the information recording medium 101.

An address detection circuit 103 detects address information of the information recording medium 101 based on the readout information. The address information is read out by a CPU (Central Processing Unit) 104. Thus, the CPU 104 recognizes the present address of the information recording medium 101.

An input section 210 is supplied with user data to be recorded. The user data is supplied to a recording pattern creation circuit 211. The recording pattern creation circuit 211 creates a signal having a recording pattern as shown in FIG. 1A based on the input user data.

The signal is input to a recording pattern detection circuit 212. The recording pattern detection circuit 212 detects the waveform of a recording pattern based on the input signal, creates timing information of the rise or fall thereof and supplies the same to a recording waveform control signal creation circuit 213.

The recording waveform control signal creation circuit 213 creates a recording waveform control signal so as to attain a recording waveform as shown in FIG. 1B and supplies the recording waveform control signal to a semiconductor laser driving circuit 214.

The operation of the semiconductor laser driving circuit 214 and the output timing of the recording waveform control signal from the recording waveform control signal creation circuit 213 are controlled by the CPU 104. That is, when user data is to be recorded, it is necessary to record the data in a location designated by an adequate address.

The semiconductor laser driving circuit 214 drives a semiconductor laser unit 215 by use of a pulse train of a recording waveform corresponding to the recording waveform control signal. As a result, laser light output from the semiconductor laser unit 215 is applied to the information recording surface of the information recording medium 101 via an optical system (not shown).

During the information recording operation, as explained with reference FIG. 1B, the power of laser light is controlled to be switched. The power switching information is created by the CPU 104 which recognizes the recording waveform control signal of the recording waveform control signal creation circuit 213.

The power switching information is supplied from the CPU 104 to a light output setting circuit 216. The light output setting circuit 216 controls the output level (intensity of the laser light) of the semiconductor laser driving circuit 214 so that powers of various levels explained in FIG. 1B can be obtained from the semiconductor laser driving circuit 214 based on the input power switching information.

In FIG. 4, the CPU 104 and the recording waveform control signal creation circuit 213 are indicated as different blocks, but they can be integrally formed as a system control section.

If the information recording medium 101 is an optical disk and the information recording/reproduction apparatus is an optical disk apparatus, for example, a spindle motor which rotates the optical disk, an optical pickup which concentrates laser light on the optical disk and the like are additionally used.

Further, in order to concentrate a laser light spot along the recording track of the optical disk in an optimum state, a focusing servo function, tracking servo function and the like are additionally used.

When the information recording medium 101 is loaded on the information recording/reproduction apparatus, it reads out information associated with the information recording condition from the information recording medium 101 by use of the information reproduction section 102. Further, the information recording/reproduction apparatus sets initial values of the light output setting circuit 216, recording waveform control signal creation circuit 213 and the like. Then, the information recording/reproduction apparatus reads out address information of the information recording medium 101 by use of the address detection circuit 103.

If user data which is desired to be recorded is input to the recording pattern creation circuit 211, the recording pattern creation circuit 211 outputs a signal having a recording pattern as shown in FIG. 1A. The recording pattern detection circuit 212 reads out a recording pattern from the signal and outputs the readout result to the recording waveform control signal creation circuit 213.

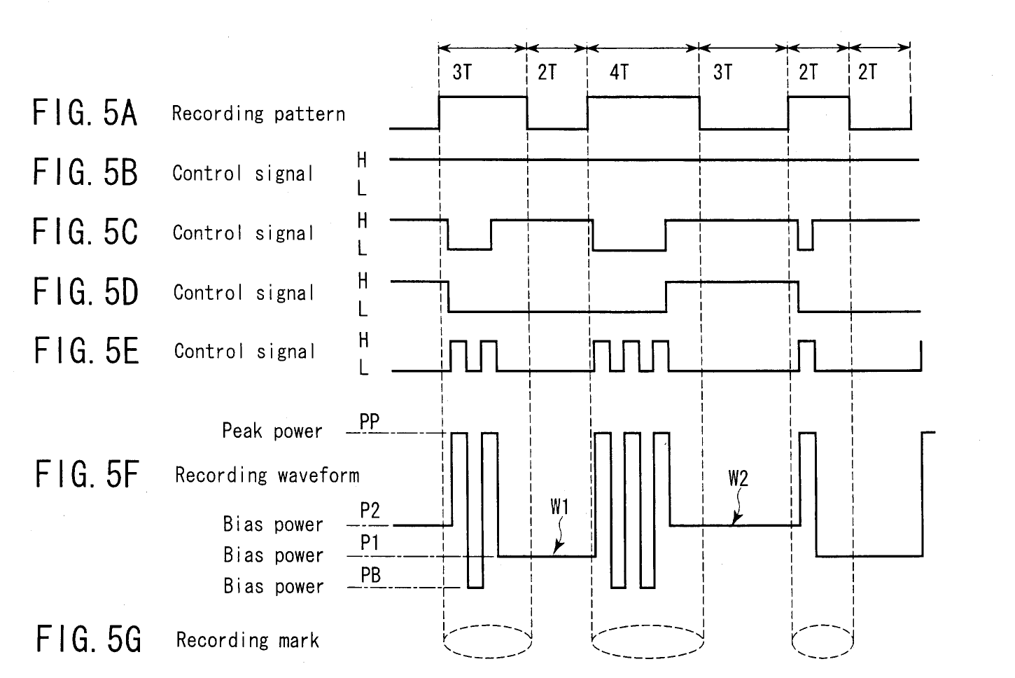

FIGS. 5A to 5G show examples of the signal waveforms of the respective sections of the information recording/reproduction apparatus. FIG. 5A shows a recording pattern. FIGS. 5B to 5E show examples of the recording waveform control signal output from the recording waveform control signal creation circuit 213. Further, FIG. 5F shows the state of a variation in the power of laser light output from the semiconductor laser unit 215.

In this example, a space shorter than the predetermined specified length is detected by monitoring a recording pattern (FIG. 5A) in addition to the operation of controlling the pulse width used in the DVD-RAM, for example.

Then, in the short space segment, a recording waveform control signal which permits the bias power P1 to be attained is output. When the recording pattern is longer than the specified length, a recording waveform control signal which permits the bias power P2 to be attained is output. In the example shown in FIG. 5F, a state in which the bias power P1 is set in a segment W1 and the bias power P2 is set in a segment W2 is shown.

The semiconductor laser driving circuit 214 drives the semiconductor laser contained in the semiconductor laser unit 215 based on the recording waveform control signal and the setting value of the light output setting circuit 216 corresponding to the recording waveform control signal. The output waveform of the semiconductor laser driving circuit 214 is equivalent to that shown in FIG. 5F. By the above operation, recording marks shown in FIG. 5G are formed on the information recording medium 101.

(Driving Method of LD (Laser Diode)) p FIG. 6 shows one example of the semiconductor laser unit 215. A semiconductor laser 300 contained in the semiconductor laser unit 215 emits light in response to a current output from a constant current source 310.

The constant current source 310 is configured by a plurality of (in this example, four) parallel-connected constant current circuits 301 to 304. An output current value of the constant current source 310 is determined by the setting value of the light output setting circuit 216.

Switching of the constant current circuits 301 to 304 to be used is made by use of switching elements 311 to 314. The switching elements 311 to 314 are respectively switched based on the recording waveform control signals (FIGS. 5B to 5E) output from the recording waveform control signal creation circuit 213 by use of the semiconductor laser driving circuit 214.

In the case of a current adding type driving method, for example, the output current value of the constant current circuit 301 is so set that laser light of the output level used for reproduction, that is, laser light at a level of the bias power PB can be output.

The output current value of the constant current circuit 302 is so set that the added current thereof with the output current of the constant current circuit 301 will permit laser light at a level of the bias power P1 to be output.

Further, the output current value of the constant current circuit 303 is so set that the added current thereof with the output currents of the constant current circuits 301, 302 will permit laser light at a level of the bias power P2 to be output.

Also, the output current value of the constant current circuit 304 is so set that the added current thereof with the output current of the constant current circuit 301 will permit laser light at a level of the peak power PP to be output.

Then, the switching elements 311 to 314 are driven by the semiconductor laser driving circuit 214 based on a combination of logical values of the recording waveform control signals shown in FIGS. 5B to 5E as explained before.

That is, when the recording waveform control signals shown in FIGS. 5B to 5E are “1000”, the semiconductor laser driving circuit 214 turns ON only the switching element 311 so as to output the bias power PB.

When the recording waveform control signals shown in FIGS. 5B to 5E are “1100”, the semiconductor laser driving circuit 214 turns ON the switching elements 311, 312 so as to output the bias power P1.

When the recording waveform control signals shown in FIGS. 5B to 5E are “1110”, the semiconductor laser driving circuit 214 turns ON the switching elements 311, 312, 313 so as to output the bias power P2.

When the recording waveform control signals shown in FIGS. 5B to 5E are “1001”, the semiconductor laser driving circuit 214 turns ON the switching elements 311, 314 so as to output the peak power PP.

The peak power PP corresponds to an output level of laser light which is optimum to melt the information recording medium 101. The bias power PB corresponds to an output level of laser light which is equivalent to that of reproduction power. The bias power P2 corresponds to an output level of laser light which is optimum to perform the erase operation for a long space, that is, P3t shown in FIG. 2. The bias power P1 corresponds to an output level of laser light which is optimum to perform the erase operation for a short space, that is, P2t shown in FIG. 2.

When a signal of the recording pattern shown in FIG. 5A is recorded by use of the recording waveform shown in FIG. 5F, the rapid cooling effect can be attained so as to precisely record a 3T recording mark even if a 2T space exists immediately after the 3T recording mark, for example, since erase power specified by the bias power P1 is sufficiently low.

In the 2T space portion, heat amounts used to record a 3T recording mark and 4T recording mark lying before and after the 2T space portion are transmitted thereto and the temperature of the information recording medium 101 reaches the crystallization temperature so that the recording mark can be overwritten and erased.

Further, when a 3T space exists after a 4T recording mark, the 4T recording mark can be precisely recorded since the space length is large and thermal interference is weak. In the 3T space portion, since optimum erase power specified by the bias power P2 is output, the recording mark can be overwritten and erased. Even when the output levels fluctuates due to the temperature characteristic of the circuit and the like, a sufficiently large margin can be attained since the erase power is optimized according to the space length.

Thus, by using the write strategy of the present embodiment, a problem of the thermal interference in the high-density recording operation can be solved, the erase characteristic can be improved and the recording mark creation precision can be enhanced.

Further, the robust characteristic with respect to the erase power can be enhanced. Also, since the rapid cooling effect can be attained even if the off pulse is not used, the number of switching operations of the output level of laser light can be reduced and the control operation of the driving circuit can be performed at high speed in a simple fashion.

In the present embodiment, one example of the current adding type driving method is explained, but the same effect can be achieved by using a different adding method if two types of power levels can be provided for the erase power.

Further, when a current switching type driving method is used, the output current value of the constant current circuit 301 is set so as to generate an output level of laser light for reproduction, that is, bias power PB.

Further, the output current value of the constant current circuit 302 is set so as to generate the bias power P1, the output current value of the constant current circuit 303 is set so as to generate the bias power P2, and the output current value of the constant current circuit 304 is set so as to generate the peak power PP. Then, the switching elements 311 to 214 are switched at timings at which the output currents of the respective constant current circuits 301 to 304 are output.

In the present embodiment, the bias power P1 is output in the case of a 2T space and the bias power P2 is output in the case of a space longer than the 2T space. However, it becomes necessary to change the threshold value which is used to switch the bias power depending on the degree of thermal interference. For example, it is possible to output the bias power P1 in the case of a 2T space and 3T space and output the bias power P2 in the case of a space longer than the 3T space.

For example, if an EFM (Eight to Fourteen Modulation) system or the like is used as the modulation system, it is possible to output the bias power P2 in the case of a 3T space and output the bias power P1 in the case of a space longer than the 3T space.

Further, as a laser light source used for recording, not only the semiconductor laser but also a gas laser or solid-state laser can be used, and in this case, the same effect as described before can be attained. In addition, in the above-described embodiment, a case wherein two levels of erase power are used is explained, but it is of course possible to use a larger number of erase power levels.

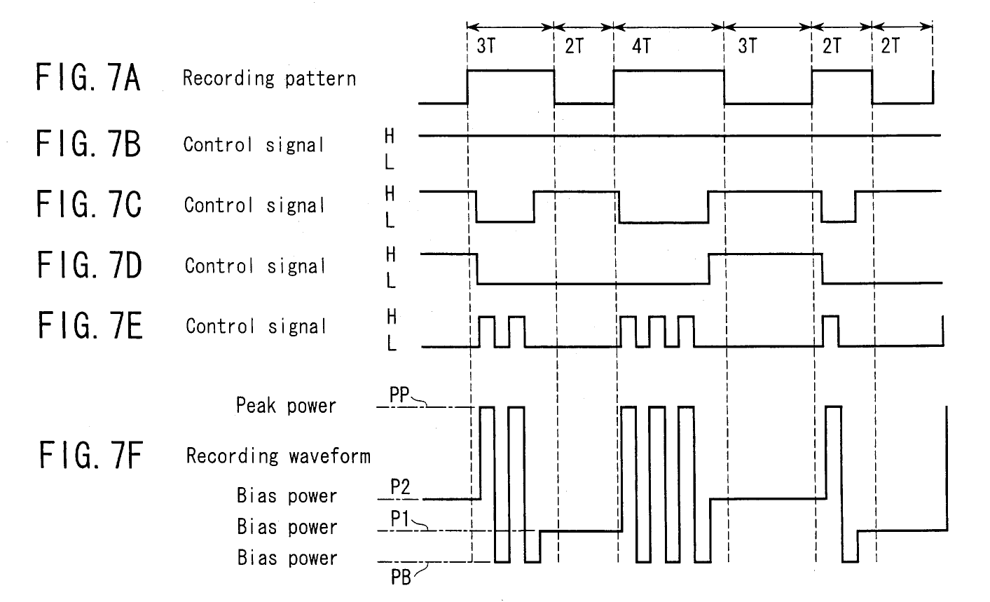

FIGS. 7A to 7F shows another example of the write strategy when an off pulse is used.

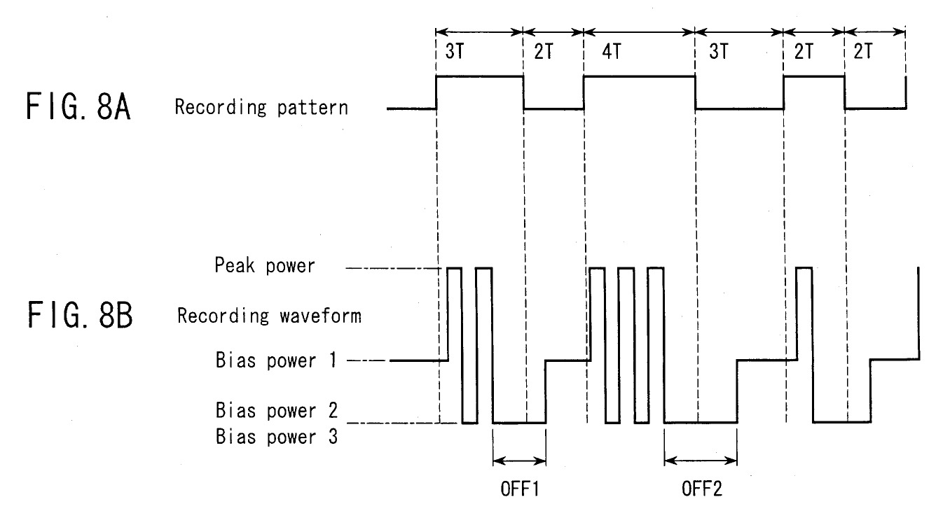

Like the conventional case, in the write strategy in which only one erase power level is used, it is necessary to use a relatively long off pulse (segments OFF1, OFF2) as in the write strategy shown in FIG. 8B depending on the characteristic of the information recording medium 101. In this case, FIG. 8A shows a recording pattern and FIG. 8B shows the recording waveform of laser light.

However, if the above write strategy is used, an output of peak power appears directly after the off pulse and there occurs a problem that it is difficult to drive the semiconductor laser.

In addition, there occurs a problem that the erase operation cannot be adequately performed since the off pulse is long, and the recording mark formed by the rapid cooling effect due to the off pulse will be shrunk by leakage of erase power which is generated after this process.

Therefore, in the write strategy of the present embodiment, the erase power of two levels is used in addition to the off pulse to solve the above problem.

That is, the length of the off pulse can be reduced and the recording mark can be prevented from being shrunk after the end of the off pulse by setting the erase power to the level of the bias power P1 for a space which causes strong thermal interference, that is, a short space so as to reduce the thermal interference.

Further, the satisfactory erase rate can be attained by setting the erase power to the level of the bias power P2 for a long space which causes weak thermal interference.

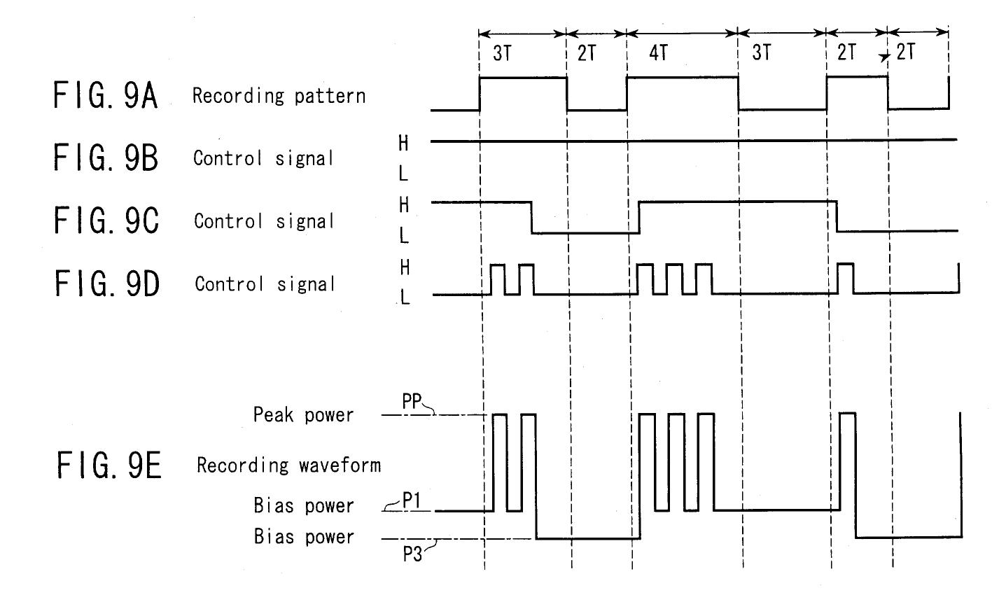

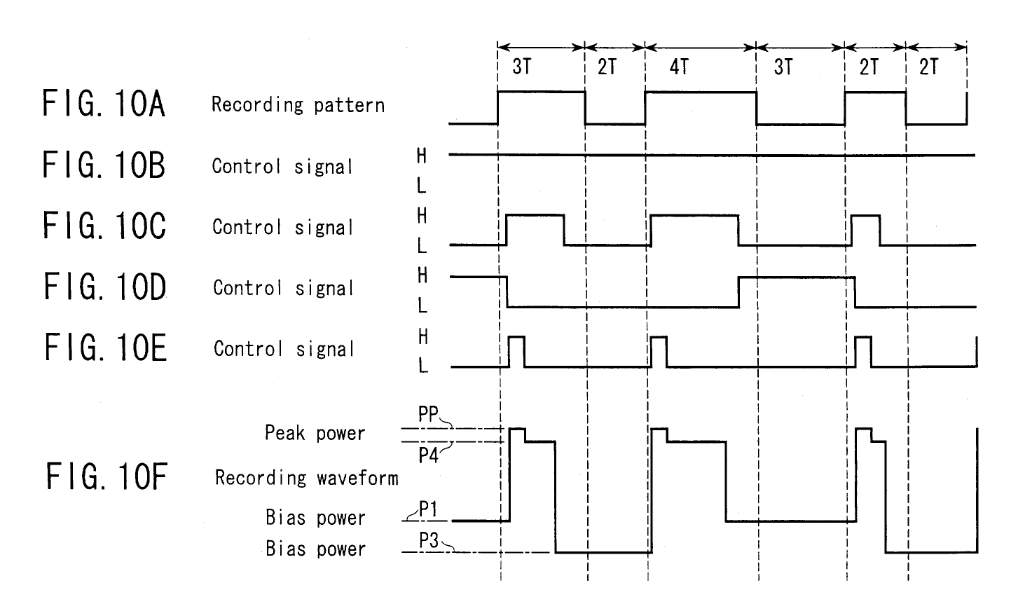

The present invention is not limited to the above embodiment. For example, when the present invention is applied to the write strategy in which the multi-bottom is not utilized as shown in FIGS. 9A to 9E or to the write strategy in which the pulse is not divided into small portions as shown in FIGS. 10A to 10F, the effects thereof can be securely attained.

FIG. 9A shows a recording pattern, FIGS. 9B to 9D show recording waveform control signals and FIG. 9E shows a recording waveform. In the recording waveform, bias power P3 is set. In comparison with the recording waveform shown in FIG. 7F, the bottom power PB used to perform the cooling operation is not provided and the power level used to perform the cooling operation is set at the level of the bias power P1.

FIG. 10A shows a recording pattern, FIGS. 10B to 10E show recording waveform control signals and FIG. 10F shows a recording waveform. In the recording waveform, a power level P4 is set immediately after the peak power PP. In this example, the power level P4 is given at a timing at which the information recoding medium 101 is melted to attain the amorphous state.

In the above embodiment, when laser light is applied to the information recoding medium 101 to record information thereon, the laser light is divided into pulses at a plurality of output levels and controlled to record and erase information by selectively switching the output levels.

In this case, one of the output levels which corresponds to the information erase power has at least first and second levels, the first level is used when the length of a to-be-erased portion is a first length and the second level is used when the length of a to-be-erased portion is a second length.

If the length of the to-be-erased potion becomes different, the erase characteristic and the formation precision of a recording mark are deteriorated due to a difference in the degree of thermal interference in some cases. Further, if the length of the to-be-erased potion becomes different, the optimum erase level will be different.

Therefore, in the above embodiment, the erase characteristic and the formation precision of a recording mark can be enhanced and the robust characteristic of the erase level can be enhanced by using at least two types of erase levels and selecting the optimum power level according to the length (segment) of a portion to be erased.

Further, in the present embodiment, the first length is the minimum channel length in the modulation rule used when information is recorded and the second length is the other channel length. Since the degree of thermal interference is greatly different between the length of a to-be-erased portion with the minimum channel length and the other lengths, the erase characteristic can be more effectively enhanced by separately setting the conditions according to the lengths.

Also, in the present embodiment, when the first length is shorter than the second length, the first level is set at a level lower than the second level. In a case where a potion of the minimum channel length is erased, a leakage heat amount occurring when recording marks lying before and after the above portion are formed is larger than that occurring in a case where a portion of the other channel length is erased.

Therefore, it becomes possible to attain a balance between the erase levels when leakage of the heat amount occurs by setting the erase level used to erase a portion of the minimum channel length lower than the erase level used to erase a portion of the other channel length. As a result, it becomes possible to enhance the erase characteristic and the formation precision of a recording mark.

What is claimed is:

1. An information recording apparatus comprising:
a circuit which varies an output level of laser light according to length of a segment in which information is to be erased when information recorded on an information recording medium is erased by use of laser light of a preset output level.

2. An information recording apparatus comprising:
a recording section which is configured to record and erase information with respect to an information recording medium by varying an output level of laser light, and
a control section which is configured to variably change an output level used to erase information with respect to said recording section according to length of a segment in which information is to be erased.

3. An information recording apparatus according to claim 2, wherein said control section has at least two output levels used to erase information and selectively switches the output levels according to the length of a segment in which information is to be erased.

4. An information recording apparatus according to claim 2, wherein said control section sets the output level of laser light at a first level when the length of the segment in which information is to be erased is equal to a first length and sets the output level of laser light at a second level which is different from the first level when the length of the segment in which information is to be erased is equal to a second length which is different from the first length.

5. An information recording apparatus according to claim 2, wherein said control section includes a detection section which is configured to detect a segment in which information is to be erased, and a setting section which is configured to set the output level of laser light at a first level when the length of a segment detected by said detection section is equal to a first length and set the output level of laser light at a second level which is different from the first level when the length of the segment detected by said detection section is equal to a second length which is different form the first length.

6. An information recording apparatus according to claim 4, wherein said control section sets the first level lower than the second level when the first length is smaller than the second length.

7. An information recording apparatus according to claim 6, wherein the first length contains minimum channel length of information to be recorded on the information recording medium.

8. An information recording apparatus according to claim 2, wherein said control section adds currents by selectively combining output currents of a plurality of constant current sources according to the length of a segment in which information is to be erased and selectively switches the output level used to erase information.

9. An information recording apparatus according to claim 2, wherein said control section selects one of output currents of a preset number of constant current sources according to the length of a segment in which information is to be erased and selectively switches the output level used to erase information.

10. An information recording apparatus according to claim 2, wherein said recording section can selectively set the output level of laser light to peak power to heat the information recording medium to a temperature higher than a melting point thereof and melt the same, erase power to hold the temperature of the information recording medium at a crystallization temperature for a crystallization holding time, and bias power to rapidly cool the melted information recording medium and convert the same into an amorphous form.

11. An information recording apparatus according to claim 2, wherein said recording section forms recording marks formed in the amorphous form and spaces which are crystallized portions on the information recording medium in an array corresponding to information to be recorded.

12. An information recording method comprising:
recording and erasing information with respect to an information recording medium by changing output levels of laser light, and
varying an output level used to erase information according to length of a segment in which information is to be erased.

13. An information recording method according to claim 12, wherein varying the output level includes detection of a segment in which information is to be erased, and setting the output level of laser light at a first level when the length of a detected segment is equal to a first length and setting the output level of laser light at a second level which is different from the first level when the length of the detected segment is equal to a second length which is different form the first length.

14. An information recording method according to claim 13, wherein the first level is set to be lower than the second level when the first length is smaller than the second length.

15. An information recording method according to claim 14, wherein the first length contains a minimum channel length of information to be recorded on the information recording medium.
